(19) United States
(12) Patent Application Publication
(10) Pub. No.: US 2025/0335570 A1
(43) Pub. Date: Oct. 30, 2025

(54) PROCESSING METHOD USING VALIDATION KEY

(71) Applicant: Visa International Service Association, San Francisco, CA (US)

(72) Inventors: Karen Cervenka, Belmont, CA (US); Gabriela Mejia, San Francisco, CA (US); Mary Taylor, San Francisco, CA (US); Lisa De Paschalis, Orinda, CA (US)

(73) Assignee: Visa International Service Association, San Francisco, CA (US)

(21) Appl. No.: 19/192,147

(22) Filed: Apr. 28, 2025

Related U.S. Application Data
(60) Provisional application No. 63/639,874, filed on Apr. 29, 2024.

(51) Int. Cl. G06F 21/44

(52) U.S. Cl. CPC G06F 21/44

(57) ABSTRACT

A method includes receiving, from a user, a request for an interaction with a resource provider. The request includes a resource provider identifier. The method includes transmitting, to an alias directory, a resolve request message comprising the resource provider identifier and a sending entity identifier, and receiving, from the alias directory, a resolve response message having a token associated with an account of the resource provider managed by a receiving entity, and a key. The key is derived from a plurality of data elements associated with the interaction. The method also includes transmitting, to a user device operated by the user, the key, and transmitting to a receiving entity computer via a processing network, an interaction request message with the token and the key. The key is provided to a resource provider. The user obtains a resource by presenting the key to the resource provider.

### CROSS-REFERENCES TO RELATED APPLICATIONS

This application is a non-provisional application of U.S. patent application No. 63/639,874, filed on Apr. 29, 2024, which is herein incorporated by reference in its entirety.

### BACKGROUND

Push interactions can push a value from one entity to another entity. For example, a push interactions can push a value from one person's account to another person's account. However, a push interaction such as OCT (original credit transaction) from a sender user to a receiver user can be conducted via traditional payment networks. If the receiver user is a resource provider, and the push interaction is initiated by the sender user, then the resource provider may receive the value, but may not know that the sender user sent the value. Existing transaction messages passing through traditional payment networks may not have sufficient capacity or formatting to carry information about the interactions between sender users and resource providers, particularly when the interactions are complex. While additional communications could be used by the sender user to notify the resource provider that they sent the value, this can be particularly cumbersome and requires the use of additional computational resources.

Another issue to be addressed with respect to push interactions is data privacy. Credentials such as account numbers can be used to conduct push interactions. However, such credentials could be subjected to man-in-the-middle attacks if they are transmitted through networks or hacking attacks of they are stored in computer systems.

Embodiments of the invention address these and other problems, individually and collectively.

### SUMMARY

One embodiment includes a method comprising: receiving, by a sending entity computer from a user, a request for an interaction with a resource provider, the request comprising a resource provider identifier associated with the resource provider, the resource provider operating a resource provider computer; transmitting, by the sending entity computer to an alias directory, a resolve request message comprising the resource provider identifier; receiving, by the sending entity computer from the alias directory, a resolve response message comprising a token and a key, the key derived from a plurality of data elements associated with the interaction; transmitting, by the sending entity computer to a user device operated by the user, the key; and transmitting, by the sending entity computer to a receiving entity computer, an interaction request message comprising the token, the key, and a value, wherein the receiving entity computer provides the key to the resource provider computer, which validates the key.

Another embodiment of the invention includes a server computer comprising a processor, and a computer readable medium. The computer readable medium comprises code, executable by the processor, for performing a method comprising: receiving, from a user, a request for an interaction with a resource provider, the request comprising a resource provider identifier associated with the resource provider, the resource provider operating a resource provider computer; transmitting, to an alias directory, a resolve request message comprising the resource provider identifier; receiving, from the alias directory, a resolve response message comprising a token and a key, the key derived from a plurality of data elements associated with the interaction; transmitting, to a user device operated by the user, the key; and transmitting, to a receiving entity computer, an interaction request message comprising the token, the key, and a value, wherein the receiving entity computer provides the key to the resource provider computer, which validates the key.

Another embodiment includes a method comprising: receiving, by an alias directory from a sending entity computer, a resolve request message comprising the resource provider identifier and a sending entity identifier; cryptographically altering, by the alias directory, at least the resource provider identifier or data associated with the resource provider identifier, the sending entity identifier, and a value associated with an interaction between a resource provider associated with the resource provider identifier and a user to form a key; and retrieving, by the alias directory, a token associated with the resource provider identifier; generating, by the alias directory, a resolve response message comprising the token and the key; and transmitting, by the alias directory, the resolve response message to the sending entity computer.

Another embodiment includes an alias directory comprising: a processor, and a computer readable medium. The computer readable comprising code, executable by the processor to perform a method. The method comprises: receiving, from a sending entity computer, a resolve request message comprising the resource provider identifier and a sending entity identifier; cryptographically altering at least the resource provider identifier or data associated with the resource provider identifier, the sending entity identifier, and a value associated with an interaction between a resource provider associated with the resource provider identifier and a user to form a key; and retrieving a token associated with the resource provider identifier; generating a resolve response message comprising the token and the key; and transmitting, by the alias directory, the resolve response message to the sending entity computer.

These and other embodiments are described in further detail below.

### BRIEF DESCRIPTION OF THE DRAWINGS

FIG. 1 shows a flow diagram of an interaction processing method using a key according to embodiments.

FIG. 2 illustrates a block diagram of an alias directory according to embodiments.

FIG. 3 illustrates a block diagram of a sending entity computer according to embodiments.

FIG. 4 illustrates a block diagram of a user device according to embodiments.

FIG. 5 illustrates a block diagram of a receiving entity computer according to embodiments.

### TERMS

Prior to discussing embodiments of the disclosure, some terms can be described in further detail.

A “user” may include an individual or a machine that operates something. In some embodiments, a user may be associated with one or more personal accounts and/or mobile devices. The user may also be referred to as a cardholder, account holder, or consumer in some embodiments.

A “user device” may be a device that is operated by a user. Examples of user devices may include a mobile phone, a smart phone, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment. An interaction can include a transaction interaction, a data transfer interaction, an access interaction, etc.

A “resource provider” may be an entity that can provide a resource such as goods, services, information, and/or access. Examples of resource providers includes merchants, data providers, transit agencies, governmental entities, venue, and dwelling operators, etc.

A “token” may be a substitute value for a credential. A token may be a string of numbers, letters, or any other suitable characters. Examples of tokens include payment tokens, access tokens, personal identification tokens, etc.

An “Application Programming Interface” or “API” may include software specifying how components of a system should interact. The API may comprise a set of routines, protocols, and tools on which software applications may be built. An API may be used for a web-based system, operating system, database system, computer hardware or software library, and may include specifications for routines, data structures, object classes, variables, and/or remote calls.

The term “verification” and its derivatives may refer to a process that utilizes information to determine whether an underlying subject is valid under a given set of circumstances. Verification may include any comparison of information to ensure some data or information is correct, valid, accurate, legitimate, and/or in good standing.

“Account information” may include any suitable information associated with an account (e.g., a personal account number and/or payment device associated with the account). Such information may be directly related to the account or may be derived from information related to the account. Examples of account information may include a PAN (primary account number or “account number”), username, expiration date, and verification values such as CVV, dCVV, CVV2, dCVV2, and CVC3 values.

An “alias” may be nickname associated with some other information. An alias can be a phone number, e-mail address, username, etc. associated with a user's real name (e.g., John Smith). An alias can have any suitable number of type of characters. An alias can be used to conduct transfers instead of sensitive information. This preserves privacy and data security.

A “receiving entity” can be an entity that receives something, typically on behalf of a receiver. The receiving entity can manage a record (e.g., an account) of a receiver. Examples of receiving entities can include issuers, acquirers, service providers etc. A receiving entity can operate a receiving entity computer.

A “sending entity” can be an entity that sends something, typically on behalf of a sender. The sending entity can manage a record (e.g., an account) of a sender. Examples of sending entities can include issuers, acquirers, service providers etc. A sending entity can operate a sending entity computer.

An “authorizing entity” may be an entity that authorizes a request. Examples of an authorizing entity may be an issuer, a governmental agency, a document repository, an access administrator, etc.

An “issuer” may typically refer to a business entity (e.g., a bank) that maintains an account for a user. An issuer may also issue payment credentials stored on a user device, such as a cellular telephone, smart card, tablet, or laptop to the consumer.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “transfer application” can include an application facilitating the transfer of funds between multiple parties. For instance, a transfer application can include a peer-to-peer transaction application. The transfer application can be executed on a mobile device associated with a user, and the transfer application can be implemented using a server (e.g., an application server) in communication with the mobile device. The transfer application can provide an account (e.g., from a digital wallet which may be part of the transfer application or external to it) for each user. The transfer application can allow a user to select a recipient user to transfer a specified amount of funds to the recipient user. The transfer application can then transfer the specified amount from an account for the user to an account for the recipient user.

An “application server” can be a server computer that is specifically designed to run applications. For instance, an application server can perform processing tasks relating to the above-described transfer application, such as provide user account details to be displayed on the transfer application executing on the mobile device or facilitate transfer of funds between users on the transfer application.

“Credentials” may comprise any evidence of authority, rights, or entitlement to privileges. For example, access credentials may comprise permissions to access certain tangible or intangible assets, such as a building or a file. Examples of credentials may include passwords, passcodes, or secret messages. In another example, payment credentials may include any suitable information associated with and/or identifying an account (e.g., a payment account and/or payment device associated with the account). Such information may be directly related to the account or may be derived from information related to the account. Examples of account information may include an “account identifier” such as a PAN (primary account number or “account number”), a token, a subtoken, a gift card number or code, a prepaid card number or code, a user name, an expiration date, a CVV (card verification value), a dCVV (dynamic card verification value), a CVV2 (card verification value 2), a CVC3 card verification value, etc. An example of a PAN is a 16-digit number, such as “4147 0900 0000 1234”.

A “token” can include a substitute identifier for some information. For example, an interaction token may include an identifier for an interaction account that is a substitute for an account identifier, such as a primary account number (PAN). For instance, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be a random string of characters. In some embodiments, a token may be used in place of a PAN to initiate, authorize, settle or resolve a transaction. The token may also be used to represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” can include a process by which data is replaced with substitute data. For example, an account identifier (e.g., a primary account number (PAN)) may be tokenized by replacing the account identifier with a substitute number (e.g., a token) that is associated with the account identifier. Further, tokenization may be applied to other information which may be replaced with a substitute value. Tokenization may be used to enhance transaction efficiency, improve transaction security, increase service transparency, or to provide a method for third-party enablement.

A “token service provider” can include an entity including one or more server computers that generates, processes, and/or maintains tokens. A token service provider may include or be in communication with a token vault where the generated tokens are stored. Specifically, the token vault may maintain one-to-one mapping between a token and the credential (e.g., a real account identifier) represented by the token.

A “push transfer message” can include a message that causes value (e.g., funds) to be pushed from one entity to another. In some embodiments, for example, a push transaction message can be generated by the application server to initiate a transaction between a sender and a receiver to push funds to the receiver. In a push transaction, the funds transfer messaging is not first initiated by the intended recipient of the funds. The push transfer message can include user account details, a token (identified from the receiver alias) relating to the receiver, a transaction amount, and a push transfer indicator (e.g., an OCT indicator). In some instances, the push transfer message can comprise an original credit transaction (OCT) format. Push transactions such as those that use OCT (original credit transaction) messages are processed as single-message transactions, with authorization and clearing performed as a single step. This means that once an authorizing entity computer approves the push transfer message, they can make the funds immediately available to a recipient record, or recipient account, instead of waiting for a separate clearing instruction. Consequently, the push transfer transactions are non-reversable because once value is made available, the recipient can use the value immediately.

“Tokenization” is a process by which data is replaced with substitute data. For example, an account identifier (e.g., a primary account number (PAN)) may be tokenized by replacing the primary account identifier with a substitute number (e.g., a token) that may be associated with the account identifier. Further, tokenization may be applied to any other information that may be replaced with a substitute value. Tokenization may be used to enhance transaction efficiency, improve transaction security, increase service transparency, or to provide a method for third-party enablement.

A “token provider” or “token service system” can include one or more computers that service tokens. In some embodiments, a token service system can facilitate requesting, determining (e.g., generating) and/or issuing tokens, as well as maintaining an established mapping of tokens to primary account numbers (PANs) in a repository (e.g., token vault). In some embodiments, the token service system may establish a token assurance level for a given token to indicate the confidence level of the token to PAN binding. The token service system may include or be in communication with a token vault where the generated tokens are stored. The token service system may support token processing of transactions submitted using tokens by de-tokenizing the token to obtain the actual PAN and conducting a transaction using that PAN. In some embodiments, a token service system may include a tokenization computer alone, or in combination with other computers such as a transaction processing network computer. Various entities of a tokenization ecosystem may assume the roles of the token provider. For example, processing networks and issuers or their agents may become the token provider by implementing the token services according to embodiments of the present invention.

A “transaction” may be any interaction or exchange between two or more parties. For example, a transaction may include a first entity requesting resources from a second entity. In this example, the transaction is completed when the resources are either provided to the first entity or the transaction is declined.

A “transaction processing network,” or “processing network,” may refer to an electronic payment system used to accept, transmit, or process transactions made by payment devices for money, goods, or services. The processing network may transfer information and funds among authorization entities (e.g., issuers), acquirers, merchants, and payment device users.

### DETAILED DESCRIPTION

Embodiments of the disclosure are directed towards the use of push interactions where sending entities act on behalf of sender users to push values to resource providers. At the end of the interactions, the sender users may gain access to resources from the resource providers (e.g., merchants). Embodiments address interactions where the sending entities (e.g., banks which manage records (e.g., accounts) of sender users) may lack relationships with the resource providers and/or receiving entities that issue and manage accounts for the resource providers. However, with embodiments of the invention, sending entities can securely access account information of resource providers their associated receiving entities using resource provider identifiers (e.g., merchant names, phone numbers, e-mail addresses, etc.), which may be aliases. The interactions according to embodiments of the invention can be conducted digitally in real-time.

In some embodiments, to initiate a push interaction, after receiving a transfer request from the sender user, a sending entity computer associated with a sending entity can query an alias directory with a resource provider identifier associated with a resource provider to retrieve a token and a key for the push interaction. The key can be mathematically derived from a plurality of data elements associated with the push interaction. For example, the key could be a hash (or a portion thereof) of information describing the interaction and can have a small size such that it can be placed in an appropriate data field in an existing interaction request message such as a push transfer message. The sending entity computer may distribute the key to the sender user after the push interaction is initiated or completed. The sending entity computer can also transmit the push transfer message comprising the key, a value for the interaction, and the token, to a receiving entity computer operated by a receiving entity. The receipt of the push transfer message by the receiving entity computer causes it to detokenize the token to obtain a credential (e.g., an account number) associated with a record of the resource provider at the receiving entity, and immediately credit the value to a record associated with the credential. Advantageously, the sending entity can use existing network protocols and an existing payment network infrastructure (e.g., an existing payment network) to efficiently transmit the key to the receiving entity.

The receiving entity computer can transmit the key to the resource provider computer. The user can present the key to the resource provider, and the resource provider computer can determine if the key received from the sender user and the key received from the receiving entity match, thereby validating the key. The key can be used by the receiving entity as proof that the sender user paid for the resource and is authorized to receive the resource from the resource provider.

In an example interaction, a user can purchase a resource (e.g., a car) from a resource provider (e.g., a car dealer) using a sending entity such as a bank to finance the acquisition of the resource. The resource provider can receive the key from the receiving entity and also from the user and can determine if they match, thereby validating the key. Once the key is validated, the resource can be provided to the user. As the key is unique to the specific interaction being conducted, the resource provider can be assured that the sending entity has acted on behalf of the user (e.g., financed the resource) and that the user is authentic and is entitled to receive the resource.

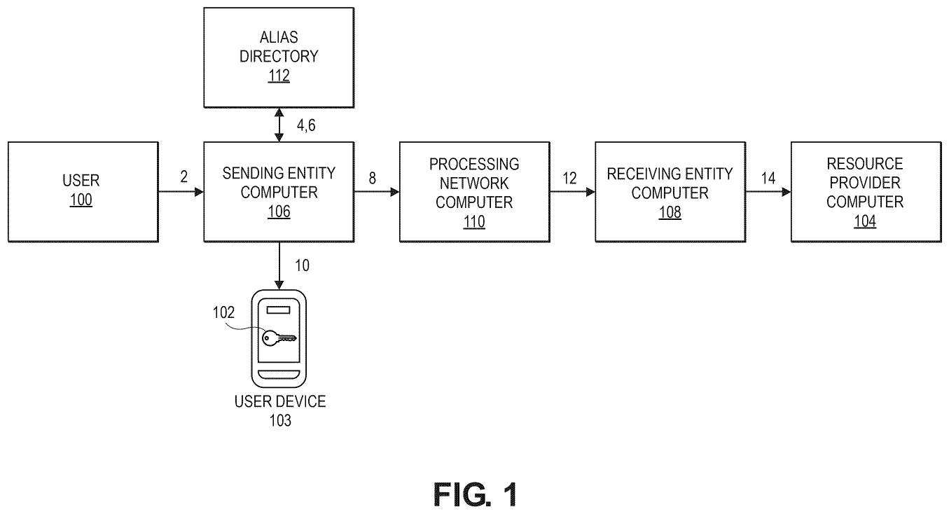

FIG. 1 shows a system diagram with an overlaid process flow according to embodiments. The method illustrated in FIG. 1 may involve a sending entity computer 106 that initiates an interaction with a resource provider computer 104 on behalf of a user 100. For example, the sending entity computer 106 may be a computer operated by a credit union providing a loan to the user 100. The user 100 may wish to finance a car from a resource provider such as an auto dealer associated with the resource provider computer 104. Embodiments are useful in this environment because the credit union may lack a relationship with the auto dealer.

For simplicity of illustration, a certain number of components are shown in FIG. 1. It should be understood, however, that embodiments of the present disclosure may include more than one of each component. In addition, some systems according to embodiments of the present disclosure may include a smaller number of components or a greater number of components than those shown in FIG. 1.

FIG. 1 shows a sending entity computer 106 that may be in operative communication with the user 100 operating a user device 103, an alias directory 112, and a processing network computer 110. The processing network computer 110 can be in communication with a receiving entity computer 108. The receiving entity computer 108 can be in communication with the resource provider computer 104 operated by the resource provider.

The receiving entity computer 108 may manage a record such as an account on behalf of the resource provider operating the resource provider computer 104. The receiving entity computer 108 may be in operative communication with resource provider computer 104 and the processing network computer 110. The receiving entity computer 108 may issue and manage a plurality of records (e.g., accounts) for a plurality of resource providers, including the resource provider operating the resource provider computer 104. The receiving entity computer 108 may be programmed to notify the resource provider operating the resource provider computer 104 when their record is credited and may provide the resource provider computer 104 with an interaction key for the interaction. The receiving entity computer 108 may operate a token service computer and may perform tokenization and de-tokenization processing.

The user 100 may operate a user device 103, which may communicate with the sending entity computer 106. For example, the user device 103 may have an interaction application installed that allows the user 100 to submit requests.

The sending entity computer 106 may manage a record such as an account on behalf of the sender user 100, and other users. In some embodiments, the sending entity computer may be an issuer computer. The sending entity computer 106 can be programmed to initiate interactions in response to receiving a user request. For example, the sending entity computer 106 use an API to request a key and token from the alias directory 112, distribute the key to the user 100 via the user device 103, and transmit an interaction request message to the processing network computer 110.

The alias directory 112 may be a server computer that stores mappings between aliases and account information (e.g., tokens) for a plurality of resource providers operating resource provider computers (including the resource provider computer 104). The alias directory 112 may be programmed to receive and respond to queries for stored account information and provide keys for interactions.

The processing network computer 110 can forward and optionally reformat interaction messages from the sending entity computer 106 to the receiving entity computer 108 in order to facilitate the interaction. The processing network computer may include data processing subsystems, networks, and operations used to support and deliver authorization services, exception file services, and clearing and settlement services. For example, the processing network computer may comprise a server coupled to a network interface (e.g., by an external communication interface), and databases of information. The processing network computer may be representative of a transaction processing network. An exemplary transaction processing network may include VisaNet™. Transaction processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The processing network computer may use any suitable wired or wireless network, including the Internet. The processing network computer 110 may operate a token service computer and may perform tokenization and de-tokenization processing.

Each of the entities in FIG. 1 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

Prior to step 2, the alias directory 112 can populated with tokens associated with resource providers that operate resource provider computers (e.g., the resource provider computer 104). For example, the receiving entity computer 108 may provide account information for a plurality of resource provider accounts to the alias directory 112. The account information can comprise data elements such as resource provider identifiers (e.g., aliases, phone numbers, e-mail addresses, entity names, entity addresses, etc.), tokens, and transit routing numbers, etc.). Credentials for records managed by the receiving entity computer 108 may have previously been tokenized by the processing network computer 110 and/or the receiving entity computer 108.

At step 2, before the user 100 can obtain a resource from the resource provider operating the resource provider computer 104, the user 100 may submit a request for an interaction (e.g., a payment transaction) to the sending entity computer 106. The user 100 may transmit the request to the sending entity computer 106 using the user device 103 (e.g., a mobile phone). The request can comprise, at least, a resource provider identifier of the resource provider computer 104 and a value to be pushed to a record of the resource provider at the receiving entity computer 104. The resource provider identifier may identify the resource provider associated with the resource provider computer 104. For example, the resource provider identifier may be a phone number, e-mail address, or entity name associated with the resource provider computer 104. The resource provider identifier may be an alias for a token associated with a resource provider.

After receiving the request from the user 100, the sending entity computer 106 may wish to initiate the interaction. However, the sending entity computer 106 may lack a relationship with the resource provider computer 104 and/or the receiving entity computer 108. As a result, the sending entity computer 106 may not have enough information to generate an interaction request message to push the value to the record of the resource provider at the receiving entity computer 108, and to route the interaction request message to the receiving entity computer 108.

At step 4, the sending entity computer 106 can determine the resource provider record (e.g., account) information in real-time using the alias directory 112. The sending entity computer 106 may query the alias directory 112, via an appropriate API, using a resolve request message.

The resolve request message can comprise the resource provider identifier received in the user request, the value, and a sending entity identifier (e.g., an originator identifier). The sending entity identifier may be an alphanumeric value that is associated with the sending entity operating the sending entity computer 106, or the sending entity computer 106 itself. Examples of the sending entity identifiers may include a name of the entity, a routing number, a loan origination number, etc.

In some embodiments, the sending entity computer 106 can use API messaging to submit the resolve request message to the alias directory 112. An exemplary API resolve request message is shown below. The resolve request message includes a resource provider identifier “1231231234,” which may be a phone number associated with the resource provider computer 104. The resolve request message further includes a sending entity identifier “456456,” and an amount for the interaction which is 1231232 USD (e.g., $12,312.32).

### API Resolve Request

{
   “resourceProviderldentifier”: “1231231234”,
   “transactionDetails”: {
      “currencyCode”: “USD”
   },
   “resourceProviderldentifierType”: “PHONE”,
“requestKey”: “Y”
   Following examples of what values could be
   “SendingEntity”: “Navy Federal Credit Union,”
   “SendingEntityldentifier”: “456456”,
   “Amount”: “1231232”
   “filters”: [
      {
         “field”: “DIRECTORY_NAME”,
         “value”: [
         “DIRECTORY_A”,
         “DIRECTORY_B”,
         “DIRECTORY_C”
         ]
      }
   ]
}

At step 6, after receiving the resolve request message, the alias directory 112 can provide a token and a key 102 to the sending entity computer 106 in a resolve response message. The alias directory 112 can search the stored account information using the resource provider identifier to obtain the token associated with the resource provider identifier. In some embodiments, the alias directory 112 may further retrieve a transit routing number (which may identify an address associated with the receiving entity computer 108) and other stored account information associated with the resource provider (e.g., a directory name, tokens associated with resource provider computer 104, a profile associated with the resource provider and/or the resource provider computer 104) and may include this information in the resolve response message.

The key 102 may be derived (e.g., a hash, encryption, etc.) from a plurality of data elements associated with the interaction. Data elements which can be in the plurality of data elements can include two or more of the following: the sending entity identifier, the value (e.g., the amount) for the interaction, a date that they key is received or issued, a time that the key is received or issued, an interaction request message identifier (e.g., a key request transaction identifier), information regarding the sender (e.g., the sender's name, address, etc.), information about the type of token associated with resource provider, the token, etc. In some embodiments, the key 102 may be a mathematically or cryptographically derived value such as a hash value computed using a hash function such as SHA-256 or other suitable hash function. In another example, a cryptographic key may be used to encrypt the plurality of data elements and the result can be truncated. The key can advantageously embody data associated with the current interaction, and can be a form that can be included in a conventional transaction message that is passed through a transaction processing network such as a credit or debit card payment network.

In some embodiments, the sending entity computer 106 may receive the resolve response message via API messaging. An exemplary API resolve response message is shown below. The data field “accountNumber” may include a token of the resource provider account, “4111111145551142.” The key may be “8795120.”

### API Resolve Response

{
   “directoryName”: “DIRECTORY_A”,
   “paymentCredentials”: [
      {
         “type”: “CARD”,
         “cardType”: “Platinum”,
         “issuerName”: “Bank A”,
         “nameOnCard”: “John Doe”,
         “accountNumber”: “4111111145551142”,
         “billingAddress”: {
         “city”: “San Francisco”,
         “state”: “CA”,
         “country”: “USA”,
         “postalCode”: “94105”,
         “streetName”: “12”,
         “addressLine1”: “1000 Market Street”,
         “addressLine2”: “Suite 101”,
         “buildingNumber”: “56”,
         “minorSubdivisionCode”: “CA”
      },
         “expirationDate”: “2026-01”,
         “lastFourDigits”: “1142”,
         “accountNumberType”: “TOKEN”,
         “modifiedOn”: “2021-01-01 T22:52:46.000Z”,
         “preferredOn”: “2021-06-21T13:00:00.323Z”,
         “preferredFor”: [
         {
         “date”: “2021-01-01T22:52:46Z”,
         “type”: “RECEIVE”
         }
         ]
      }
   ],
   “profile”: {
      “lastName”: “Miller”,
      “firstName”: “Alex”,
      “middleName”: “Robert”,
      “contactinfo”: [
         {
         “type”: “PHONE”,
         “value”: “1231234321”
         }
      ],
      “dateOfBirth”: “1980-02-01”,
      “lastNameLocal”: “Miller”,
      “preferredName”: “Miller's Shop”,
      “firstNameLocal”: “Roberto”,
      “middleNameLocal”: “Alexander”
   },
   “identification”: {
      “type”: “PASSPORT”,
      “value”: “A123456”,
      “verificationDetails”: {
         “authDateTime”: “2021-01-01T22:52:46Z”,
         “verifiedEmail”: true,
         “verifiedPhone”: false,
         “creationDateTime”: “2021-01-01 T22:52:46Z”,
         “authMethodReference”: “EXTERNAL, SMS OTP, Email OTP”
      }
   }
   “Key”: “8795120”
}

After receiving the resolve response message, the sending entity computer 106 has the information needed to generate and transmit an interaction request message (e.g., an authorization request message) to the receiving entity computer 108 via the processing network computer 116. In some embodiments, the interaction request message can be an ISO 20022 message and an OCT (original credit transaction) message. In some embodiments, the interaction request message may comprise at least the token associated with the resource provider, the amount, the transit routing number of the receiving entity computer 108, and the key.

At step 8, the sending entity computer 106 can transmit the interaction request message comprising the token and the key 102 to the processing network computer 110.

In some embodiments, the interaction request message can be a push interaction request message that, upon receipt by the receiving entity computer 108, causes value (e.g., funds) to be pushed from the account of the sender user 100 to the account of the resource provider at the resource provider computer 104. In some instances, the interaction request message may be an OCT (original credit transaction) message. Interactions such as those that use OCT messages are processed as single-message interactions, with authorization and clearing performed as a single step. This means that the receiving entity computer can make the funds immediately available to the resource provider account instead of waiting for a separate clearing instruction.

At step 10, after receiving the resolve response message from the alias directory 112, the sending entity computer 106 can transmit the key 102 to the user 100 via the user device. For example, the user 100 may receive the key 102 in an electronic statement or via a mobile application on the user device 103. Note that step can occur before, after or during steps 8, 12, and 14.

At step 12, the processing network computer 110 may forward the interaction request message comprising the key 102, the value, and the token to the receiving entity computer 108. In some embodiments, the processing network computer 110 may detokenize the token to the real credential of the resource provider (e.g., a PAN or primary account number), and transmit the real credential with the key and the value in the interaction request message to the receiving entity computer 108. In other embodiments, the receiving entity computer 108 may perform the detokenization process.

At step 14, after receiving the interaction request message from the processing network computer 110, the receiving entity computer 108 can credit the amount for the interaction to the account of the resource provider computer 104 associated with the credential. If it was not performed by the processing network computer 110, the receiving entity computer 108 may detokenize the token from the interaction request message to identify the credential associated with the resource provider record to credit. The receiving entity computer 108 may additionally provide (e.g., transmit) the key 102 to the resource provider computer 104.

After step 14, the user 100 may present the key 102 to the resource provider in order to gain access to a resource. The user 100 may transmit the key 102 to the resource provider computer 104 for verification. If the key 102 is successfully verified, the resource provider computer 104 may grant the user 100 access to the resource.

The key 102 may be verified in any suitable manner. For example, the user 100 may present the key it received from the sending entity computer 106 to the resource provider computer 104 via the user device 103. For example, the key may be encoded in a QR code by the user device 103 and presented to the resource provider computer 104. In another example, the key may be transmitted to the resource provider computer 104 electronically via a communication protocol such as NFC (near field communications), Wi-Fi™, Bluetooth™, etc. The resource provider computer 104 may compare the key received from the user device 103 to the key that it received from the receiving entity computer 108. If it matches, the resource provider computer 104 may grant the user 100 access to the resource.

After the interaction request message is received by the receiving entity computer 108, the actual transfer of funds can occur in a settlement process between the receiving entity computer 108, the processing network computer 110, and the sending entity computer 106.

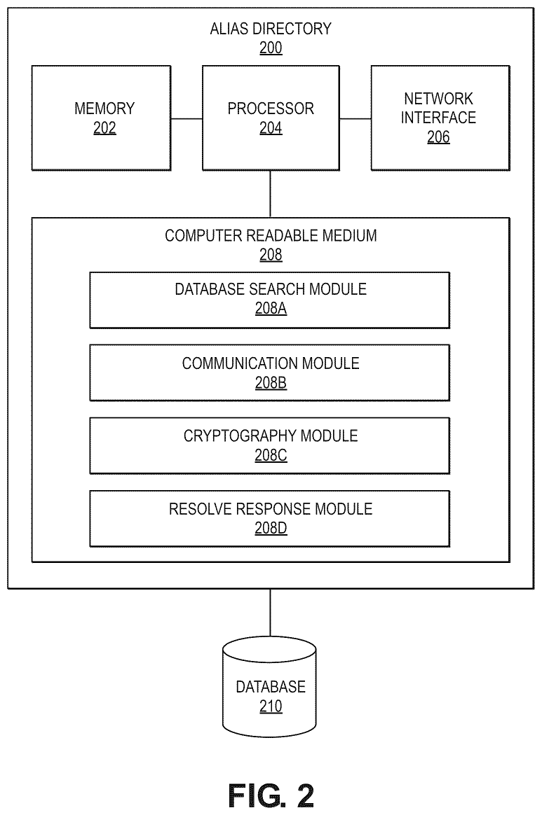

FIG. 2 illustrates a block diagram of an alias directory according to embodiments. The alias directory 200 can store and manage account information. The alias directory 200 can resolve account information based on received identifiers. For example, the alias directory 200 may resolve a resource provider identifier to a token using stored account information. The alias directory 200 may additionally generate keys for interactions. For example, the alias directory 200 may generate a key using a plurality of data elements associated with an interaction.

The alias directory 200 may comprise a processor 204 coupled to a memory 202, a network interface 206 and a computer readable medium 208. The computer readable medium 208 can comprise a database search module 208A, a communication module 208B, and a cryptography module 208C, and a resolve response module 208D. The alias directory 200 can be in operative communication with a database 210.

The memory 202 can be used to store data and code. The memory 202 may be coupled to the processor 204 internally or externally (e.g., cloud-based data storage), and may comprise any combination of volatile and/or non-volatile memory, such as RAM, DRAM, ROM, flash, or any other suitable memory device. For example, the memory 202 can store credentials, tokens, resource provider identifiers, account information, etc.

The memory 202 may comprise a computer readable medium comprising code, executable by the processor, to perform a method comprising: receiving, from a sending entity computer, a resolve request message comprising the resource provider identifier and a sending entity identifier; cryptographically altering at least the resource provider identifier or data associated with the resource provider identifier, the sending entity identifier, and a value associated with an interaction between a resource provider associated with the resource provider identifier and a user to form a key; and retrieving a token associated with the resource provider identifier; generating a resolve response message comprising the token and the key; and transmitting, by the alias directory, the resolve response message to the sending entity computer.

The database search module 208A may comprise code or software, executable by the processor 204, for searching a database and obtaining data from the database. The database search module 208A, in conjunction with the processor 204, can search a database, such as the database 210, for tokens, resource provider identifiers, and account information.

For example, the database search module 208A, in conjunction with the processor 204, may receive a resource provider identifier. The database search module 208A, in conjunction with the processor 204, can determine whether or not the resource provider identifier is included in the database 210. If the resource provider identifier is included in the database 210, then the database search module 208A, in conjunction with the processor 204, can obtain any data that is stored in association with the resource provider. The resource provider identifier, for example, can be stored in association with account information of the resource provider such as a token, a transit routing number, credentials, etc. The database search module 208A, in conjunction with the processor 204, can obtain the account from the database 210.

The communication module 208B that may comprise code that causes the processor 204 to generate messages, forward messages, reformat messages, and/or otherwise communicate with other entities. When an electronic message is received by the alias directory 200 via the network interface 206, it may be passed to the communication module 208B. The communication module 208B, in conjunction with the processor 204, may identify and parse the relevant data based on a particular messaging protocol used in the system. The communication module 208B, in conjunction with the processor 204, may then transmit any received information to an appropriate module within the alias directory 200 (e.g., via a data bus line, etc.). The communication module 208B may also receive information from one or more of the modules in the alias directory 200 and generate an electronic message in an appropriate data format in conformance with a transmission protocol, such that the message may be sent to one or more entities. The electronic message may then be passed to the network interface 206 for transmission.

The cryptography module 208C may comprise code that causes the processor 204 to provide cryptographic functionalities. The cryptography module 208C may enable the alias directory 200 to generate keys based on a plurality of data elements. For example, during key generation, the cryptography module 208C may encrypt or hash a plurality of data elements associated with the interaction, including a sending entity identifier and an amount for the interaction. For example, cryptography module 208C may implement and perform encryption operations using encryption algorithms such as DES, AES, TDES/TDEA, or the like, and/or hash functions such as SHA, or the like.

The resolve response module 208D may comprise code that causes the processor 204 to generate a resolve response message. The resolve response module 208D can generate a key and retrieve a token in response to processing a resolve response request. The key may be generated in real time using API calls.

The network interface 206 may include an interface that can allow the alias directory 200 to communicate with external computers. The network interface 206 may enable the alias directory 200 to communicate data to and from another device. Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The database 210 can include any suitable database. The database 210 may be a conventional, fault tolerant, relational, scalable, secure database such as those commercially available from Oracle™ or Sybase™. The database 210 can include a plurality of directories for a plurality of resource provider categories. The database 210 can store credentials, tokens, resource provider identifiers, and other account information for a plurality of resource providers.

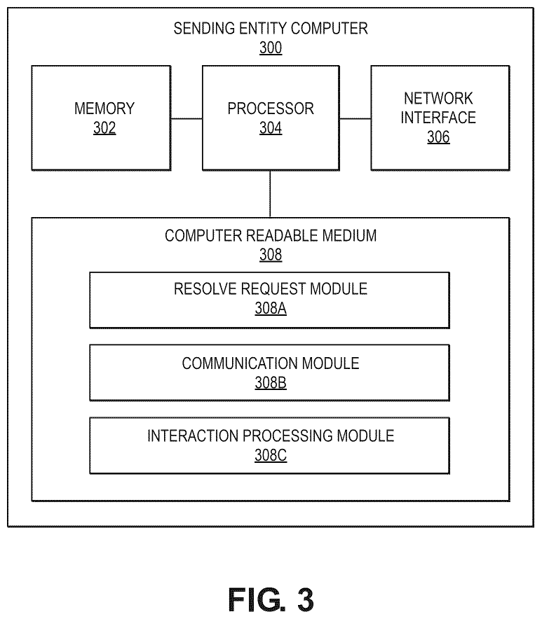

FIG. 3 illustrates a block diagram of a sending entity computer according to embodiments. The sending entity computer 300 may include a processor 304 coupled to a memory 302, a network interface 306 and a computer readable medium 308. The computer readable medium 308 can comprise a resolve request module 308A, a communication module 308B, and an interaction processing module 308C.

The computer readable medium 308 may comprise code, executable by the processor 304, for performing a method comprising: receiving, from a user, a request for an interaction with a resource provider, the request comprising a resource provider identifier associated with the resource provider, the resource provider operating a resource provider computer; transmitting, to an alias directory, a resolve request message comprising the resource provider identifier; receiving, from the alias directory, a resolve response message comprising a token and a key, the key derived from a plurality of data elements associated with the interaction; transmitting, to a user device operated by the user, the key; and transmitting, to a receiving entity computer, an interaction request message comprising the token, the key, and a value, wherein the receiving entity computer provides the key to the resource provider computer, which validates the key.

The resolve request module 308A may be programmed to obtain tokens and keys for interactions. The resolve request module 308A can comprise code, executable by the processor 304, for submitting resolve request messages to the alias directory to obtain tokens and keys. The interaction processing module 308C may be programmed to process interactions.

The memory 302 can be similar to the memory 202 and will not be repeated here. The communication module 308B can be similar to the communication module 208B and will not be repeated here. The network interface 306 can be similar to the network interface 206 and will not be repeated here.

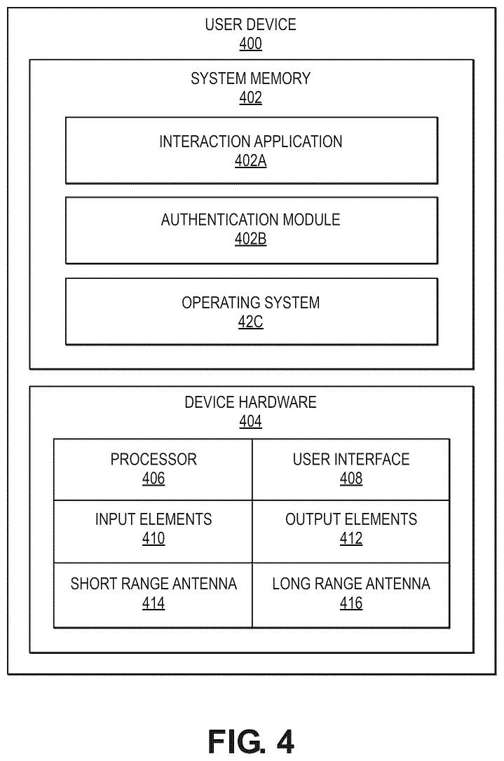

FIG. 4 illustrates a diagram of a user device 400 according to an embodiment. The user device 400 may include device hardware 404 coupled to a system memory 402.

Device hardware 404 may include a processor 406, a short range antenna 414, a long range antenna 416, input elements 410, a user interface 408, and output elements 412 (which may be part of the user interface 408). Examples of input elements may include microphones, keypads, touchscreens, sensors, etc. Examples of output elements may include speakers, display screens, and tactile devices. The processor 406 can be implemented as one or more integrated circuits (e.g., one or more single core or multicore microprocessors and/or microcontrollers), and is used to control the operation of user device 400. The processor 406 can execute a variety of programs in response to program code or computer-readable code stored in the system memory 402, and can maintain multiple concurrently executing programs or processes.

The long range antenna 416 may include one or more RF transceivers and/or connectors that can be used by user device 400 to communicate with other devices and/or to connect with external networks. The long range antenna 416 may be configured to communicate with a remote base station and a remote cellular or data network, over the air. The short range antenna 409 may be configured to communicate with external entities through a short range communication medium. The short range antenna 409 may comprise a contactless interface that can interact with a contactless interface of another device (e.g., a portable device). Examples of a contactless interface may include one or more radio frequency (RF) transceivers that can send and receive communications using near-field communications (NFC), or other radio frequency or wireless communication protocols. The user interface 408 can include any combination of input and output elements to allow a user to interact with and invoke the functionalities of the user device 400.

The system memory 402 can be implemented using any combination of any number of non-volatile memories (e.g., flash memory) and volatile memories (e.g., DRAM, SRAM), or any other non-transitory storage medium, or a combination thereof media. The system memory 402 may store computer code, executable by the processor 406, for performing any of the functions described herein. For example, the system memory 402 may comprise a computer readable medium comprising code, executable by the processor 406, for implementing a method comprising: transmitting, to a sending institution computer, a request for an interaction with a resource provider, the request comprising a resource provider identifier associated with the resource provider, the resource provider operating a resource provider computer; receiving, from the sending institution computer, a key derived from a plurality of data elements associated with the interaction by an alias directory, wherein the key is provided to the resource provider computer after a receiving institution computer receives the key in an interaction request message from the sending institution computer; and transmitting, to the resource provider computer, the key for verification, wherein after the key is verified the user obtains a resource from the resource provider.

The system memory 402 may also store an interaction application 402A, an authentication module 402B, and an operating system 402C. The interaction application 402A may include instructions or code executable by the processor 406 for communicating with a sending entity computer. For example, the interaction application 402A may comprise logic, executable by the processor 406 for transmitting a request message (e.g., to a sending entity computer) and receiving a key during an interaction. The authentication module 402B may comprise code, executable by the processor 406, to authenticate a user. This can be performed using user secrets (e.g., passwords) or user biometrics.

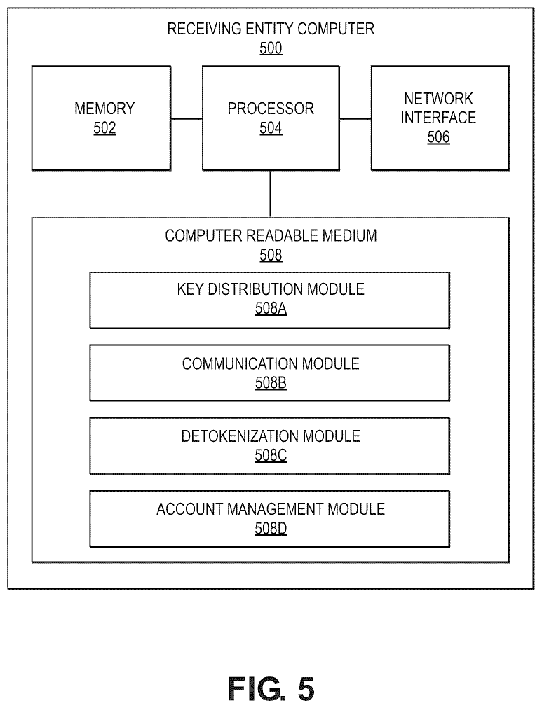

FIG. 5 illustrates a block diagram of a receiving entity computer according to embodiments. The receiving entity computer 500 may include a processor 504 coupled to a memory 502, a network interface 506 and a computer readable medium 508. The computer readable medium 508 can comprise a key distribution module 508A, a communication module 508B, a detokenization module 508C, and an account management module 508D.

The computer readable medium 508 comprises code, executable by the processor 504 to perform a method. The method comprises: receiving an interaction request message comprising a token, a value, and a key, the interaction request message for an interaction between a resource provider and a user; detokenizing the token to obtain a credential; authorizing the interaction based on the credential and the value; and transmitting the key to a resource provider computer associated with the resource provider, wherein the resource provider computer also receives the key from a user device of the user and validates the key by comparing the key from the receiving entity computer to the key from the user device before providing a resource to the user.

The key distribution module 508A may comprise code that causes the processor 504 to provision a key. For example, the key distribution module 508A may contain logic that causes the processor 504 to provide a key received in an interaction request message to a resource provider computer associated with the interaction.

The detokenization module 508C can comprise code that causes the processor 504 to detokenize tokens. For example, the detokenization module 508C may contain logic that causes the processor 504 to identify an account associated with a token received in an interaction request message. In some embodiments, the detokenization module 508C may query a token vault to determine the underlying account.

The account management module 508D may comprise code that causes the processor 504 to issue and manage accounts on behalf of account owners (e.g., resource providers). For example, the account management module 508D may contain logic that causes the processor 504 to credit an account with an amount for an interaction.

The memory 302 can be similar to the memory 202 and will not be repeated here. The communication module 308B can be similar to the communication module 208B and will not be repeated here. The network interface 306 can be similar to the network interface 206 and will not be repeated here.

Further embodiments of the invention can be contemplated.

One embodiment of the invention includes a method comprising: transmitting, by a user device to a sending institution computer, a request for an interaction with a resource provider, the request comprising a resource provider identifier associated with the resource provider, the resource provider operating a resource provider computer; receiving, by the user device from the sending institution computer, a key derived from a plurality of data elements associated with the interaction by an alias directory, wherein the key is provided to the resource provider computer after a receiving institution computer receives the key in an interaction request message from the sending institution computer; and transmitting, by the user device to the resource provider computer, the key for verification, wherein after the key is verified the user obtains a resource from the resource provider.

Another embodiment of the invention includes a user device programmed to perform the above method.

Another embodiment of the invention includes a method comprising: receiving by a receiving entity computer, an interaction request message comprising a token, a value, and a key, the interaction request message for an interaction between a resource provider and a user; detokenizing, by the receiving entity computer, the token to obtain a credential; authorizing the interaction based on the credential and the value; and transmitting, by the receiving entity computer, the key to a resource provider computer associated with the resource provider, wherein the resource provider computer also receives the key from a user device of the user and validates the key by comparing the key from the receiving entity computer to the key from the user device before providing a resource to the user.

Another embodiment of the invention includes a receiving entity computer programmed to perform the above method.

Embodiments of the disclosure have a number of technical advantages. Embodiments provide a secure way to source account credentials using public information and enable interactions to take place digitally in real time, even when it involves multiple entities that lack relationships. Embodiments can distribute a key that can validate that a user is a party to the interaction when the interaction is initiated by another entity. The key is distributed efficiently to all of the entities involved in the interaction without disrupting existing messages in existing transaction systems. Further, by using access data in the form of a token, sensitive data such as an account identifier is protected from man in the middle attacks and the like.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a sending entity computer from a user, a request for an interaction with a resource provider, the request comprising a resource provider identifier associated with the resource provider, the resource provider operating a resource provider computer;
transmitting, by the sending entity computer to an alias directory, a resolve request message comprising the resource provider identifier;
receiving, by the sending entity computer from the alias directory, a resolve response message comprising a token and a key, the key derived from a plurality of data elements associated with the interaction;
transmitting, by the sending entity computer to a user device operated by the user, the key; and
transmitting, by the sending entity computer to a receiving entity computer, an interaction request message comprising the token, the key, and a value,
wherein the receiving entity computer provides the key to the resource provider computer, which validates the key.

2. The method of claim 1, wherein prior to the receiving entity computer receiving the interaction request message, a processing network computer detokenizes the token to obtain a credential and forwards the interaction request message comprising the credential, the key, and the value to the receiving entity computer.

3. The method of claim 1, wherein the alias directory comprises a plurality of tokens associated with a plurality of resource providers.

4. The method of claim 1, wherein the plurality of data elements comprise an identifier for the sending entity computer, the value, a date when the key was requested or issued, and a key request transaction identifier.

5. The method of claim 4, wherein the key is a hash value.

6. The method of claim 1, wherein the key is cryptographically derived from plurality of data elements.

7. The method of claim 1, wherein the key is provided by the receiving entity computer to the resource provider computer after the receiving entity computer detokenizes the token to obtain a credential associated with the token.

8. The method of claim 1, wherein the user obtains a resource from the resource provider after the resource provider computer verifies the key by determining that the key received from the receiving entity computer matches a key received from the user device of the user.

9. The method of claim 1, wherein the interaction request message is an OCT message.

10. The method of claim 1, wherein the interaction request message comprising the token, the key, and the value is received by the receiving entity computer and the receiving entity computer thereafter detokenizes the token to obtain a credential, the credential associated with a record managed by the receiving entity computer.

11. A computer comprising:
a processor; and
a non-transitory computer readable medium comprising instructions executable by the processor to perform a method comprising:
receiving, from a user, a request for an interaction with a resource provider, the request comprising a resource provider identifier associated with the resource provider, the resource provider operating a resource provider computer;
transmitting, to an alias directory, a resolve request message comprising the resource provider identifier;
receiving, from the alias directory, a resolve response message comprising a token and a key, the key derived from a plurality of data elements associated with the interaction;
transmitting, to a user device operated by the user, the key; and
transmitting, to a receiving entity computer, an interaction request message comprising the token, the key, and a value,
wherein the receiving entity computer provides the key to the resource provider computer, which validates the key.

12. The computer of claim 11, wherein the resolve request message is an API request message.

13. The computer of claim 11, wherein the plurality of data elements comprise a sending entity identifier and the value.

14. The computer of claim 11, wherein the interaction request message is an OCT message.

15. The computer of claim 11, wherein the computer is a sending entity computer.

16. The computer of claim 11, wherein the key is a hash value.

17. The computer of claim 11, wherein the resource provider identifier is an alias for the token.

18. The computer of claim 11, wherein the token is associated with a credential, which is associated with a record managed by a receiving entity computer.

19. A method comprising:
receiving, by an alias directory from a sending entity computer, a resolve request message comprising a resource provider identifier and a sending entity identifier;
cryptographically altering, by the alias directory, at least the resource provider identifier or data associated with the resource provider identifier, the sending entity identifier, and a value associated with an interaction between a resource provider associated with the resource provider identifier and a user to form a key; and
retrieving, by the alias directory, a token associated with the resource provider identifier;
generating, by the alias directory, a resolve response message comprising the token and the key; and
transmitting, by the alias directory, the resolve response message to the sending entity computer.

20. The method of claim 19, wherein the sending entity computer generates an interaction request message comprising the token and the value and transmits the interaction request message to a receiving entity computer associated with the resource provider.
